(19) United States
(12) Patent Application Publication
(10) Pub. No.: US 2016/0371998 A1
(43) Pub. Date: Dec. 22, 2016

(54) HEALTH-BASED INCENTIVE PLANS AND SYSTEMS AND METHODS FOR IMPLEMENTING HEALTH-BASED INCENTIVE TRANSACTIONS

(71) Applicant: Benecure, Inc., Chicago, IL (US)

(72) Inventor: Muhammed Fazeel, Chicago, IL (US)

(73) Assignee: Benecure, Inc., Chicago, IL (US)

(21) Appl. No.: 14/742,082

(22) Filed: Jun. 17, 2015

(51) Int. Cl. G09B 19/00; G09B 5/02

(52) U.S. Cl. CPC G09B 19/00; G09B 5/02

(57) ABSTRACT

Technology is disclosed for generating health-based incentive plans and systems and methods for generating and implementing user-specific health-based incentive plans and transactions. The technology can receive user specific data to create a user-specific health status data set relating to at least a user's current health status and receive an incentive plan request. The technology can also generate a health-based challenge program for improving one or more aspects of the user's current health status and provide an incentive to the user based on improvement of the user's current health status.

### TECHNICAL FIELD

The present application relates generally to health-based incentive plans and systems and methods for generating and implementing health-based incentive plans and transactions.

### BACKGROUND

Healthcare professionals, health insurance companies and health-based retail businesses are incentivized to promote health and wellness of their clients and/or patients. General wellness of individuals in the United States, for example, has been declining despite the media and social pressures to improve health. Understanding and controlling disease, health-related conditions and other aspect of physical and psychological wellness are challenging tor those individuals wanting to improve their health related quality of life.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a block diagram of a basic and suitable computing device that may employ aspects of the present technology.

FIG. 2 is a block diagram illustrating a simple, yet suitable system in which aspects of the present technology may operate in a networked computer environment.

FIG. 3 is a schematic block diagram illustrating a health-based incentive plan system for generating user-specific incentive plans in accordance with embodiments of the present technology.

FIGS. 4A-5B are schematic block diagrams illustrating environments in which the health-based incentive plan system may operate in accordance with an embodiment of the present technology.

FIG. 6 is a schematic block diagram illustrating subcomponents of the computing device of FIGS. 1-56 in accordance with an embodiment of the present technology.

FIG. 7 is a flow diagram illustrating a routine for generating a user-specific incentive plan in accordance with an embodiment of the present technology.

FIGS. 8 and 9A-9B are flow diagrams illustrating other routines for improving one or more aspects of a user's health in accordance with aspects of the present technology.

FIG. 10A is a screen shot on a user interface in accordance with an embodiment of the present technology.

FIG. 10B is a screen shot on a user interface in accordance with another embodiment of the present technology.

### DETAILED DESCRIPTION

### A. Embodiments of Health-Based Incentive Plan Systems and Methods

1.System Overview

Systems and methods are provided herein that enable generation and implementation of a user-specific incentive plan for health improvement applications, in some embodiments, an incentive plan can be automatically generated and provided to a user and/or medical personnel, in further embodiments, the incentive plan can be further optimized, for example, to provide unique incentives, goals, productivity benchmarks and/or other health-related challenges for a particular user. The incentive plan can be based on user-specific information and health parameters, user desired health related results, general wellness knowledge information and previously acquired information relating to previously implemented incentive plans: participation in those incentive plans, and health-based benefits resulting from those incentive plans.

A health-based incentive plan system is described for providing a recommended incentive strategy and reward system for improving aspects of a user's health, disease state, lifestyle, longevity, etc, The health-based incentive plan system includes a computing device having a processor, memory and data stored in the memory, in one embodiment, the system can include a computer network for transmitting incentive plan requests, user-specific data, images, incentive plans and rewards. The health-based incentive plan system can also include a database connected to the computer network for storing a plurality of incentive plan data sets, and a plurality of incentive parameters. The incentive plan data sets can include user-specific data, images, predetermined incentive plans, general wellness knowledge information and previously acquired information relating to health conditions, incentive parameters and options, and desired results and/or benefits.

The system also includes encoded computing device instructions for providing incentive plans, health-related goals and/or challenges. The instructions (e.g., logic programming) may be stored in the memory and executable by the processor, or in another embodiment, reside on a server in communication with the computer network The instructions include logic steps that accept user-specific data describing the user's baseline health condition, logic steps that accept data relating to a desired health outcome and/or benefits, and logic steps that evaluate the user-specific baseline data and the desired outcome data relative to the plurality of incentive plan data sets. The instructions can further include logic steps that calculate a best-fit combination of incentive parameters from the plurality of incentive parameters to formulate a user-specific incentive plan.

One embodiment of the disclosure is directed to one or more algorithms to assist In the selection of a heath based incentive plan for improving a user's general health or a specific health condition (e.g., hypertension, diabetes, obesity, etc). Generally, the algorithm(s) includes the steps of 1) acquiring health-related data about the user; 2) evaluating the user-specific health-related data to automatically categorize the user's baseline health status into one or more pre-determined classification data sets or groupings; 3) acquiring selected input data about the desired health benefit outcome; 4) automatically calculating incentive parameters for achieving the desired outcome; 5) generating one or more incentive plans; 6) acquiring current and/or real-time health-related data about the user on an on-going or intermittent basis; 7) evaluating the user-specific current health-related data to determine if a reward is earned; 8) providing rewards; 9) adaptively calculating incentive parameters for achieving the desired outcome based on the current health-related data; and 10) generating one or more updated incentive plans.

In some embodiments, the algorithm(s) can include logic steps for optimizing and/or changing the anticipated health benefit outcome based upon one or more subjective criteria and/or personal preference(s). In other embodiments, the algorithm(s) can Include steps for monitoring, in real-time, incentive plan compliance and other feedback data, comparing the feedback data to projected benchmarks based upon the prediction of the anticipated health benefit outcome, and when a difference is detected between actual and predictive feedback, modifying the incentive plan in real-time such that compliance with the incentive plan achieves the anticipated health benefit outcome.

2. Suitable Computing Environments

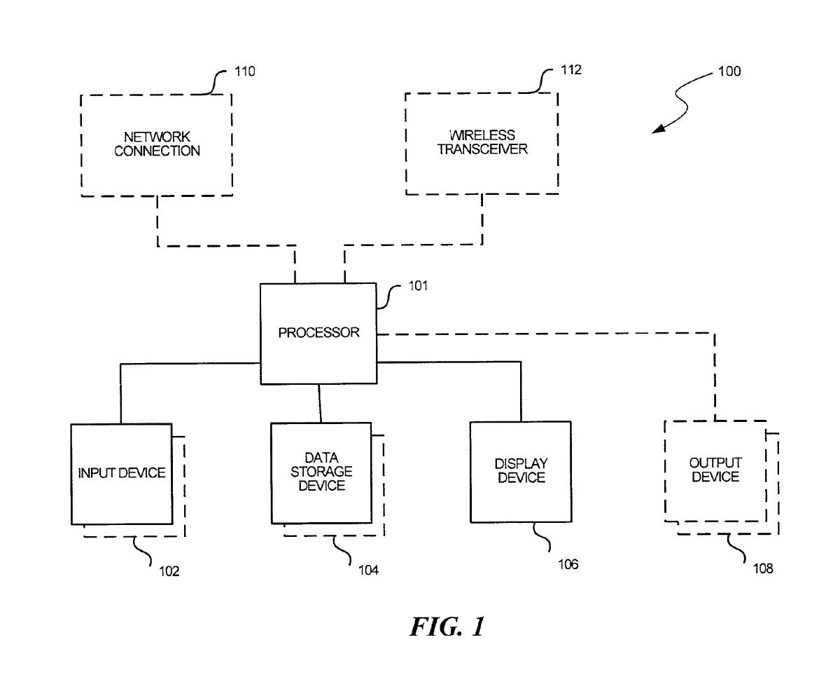

FIG. 1 and the following discussion provide a general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, band-held devices, wearable computers, cellular or mobile phones (e.g., smart phones), multi-processor systems, microprocessor-based or programmable consumer electronics, set-top boxes, network PCs, mini-computers, tablet computers, mainframe computers and the like. The disclosure can be embodied in a special purpose computer or data processor that is specifically programmed, configured or constructed to perform one of more of the computer-executable instructions explained in detail be low. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the internet or over other networks (including wireless networks). Those skilled in the relevant art will recognize that, portions of the disclosure may reside on a server computer, while corresponding portions reside on a client computer Data structures and transmission of data particular to aspects of the disclosure are also encompassed within the scope of the disclosure.

Referring to FIG. 1, one embodiment, of the technology employs a computing device 100. such as a smart phone, a personal computer or other workstation, having one or more processors 101 coupled to one or more user input devices 102 and data storage devices 104. The computing device 100 is also coupled to at least one output device such as a display device 106 and one or more optional additional output devices 108 (e.g.; printer, plotter, speakers, tactile or olfactory output devices, etc.). The computer may be coupled to external computers, such as via an optional network connection 110, a wireless transceiver 112, or both.

The input devices 102 may include a touch screen, a keyboard and/or a pointing device such as a mouse. Other input devices are possible such as a microphone, joystick, pen, touch screen, scanner, digital camera, video camera, and the like. Further input devices can include medical-related data acquisition devices (e.g., digital scale, ambulatory blood pressure monitor, clinic blood pressure monitor, temperature sensor/thermometer, heart rate monitor, pulse oximeter, etc.). The data storage devices 104 may include any type of computer-readable media that can store data accessible by the computer 100, such as magnetic hard and floppy disk drives, optical disk drives, flash drives, magnetic cassettes, tape drives, flash memory cards, digital video disks (DVDs), Bernoulli cartridges, RAMs, ROMs, smart cards, etc, indeed, any medium for storing or transmitting computer-readable instructions and data may be employed, including a connection port to or node on a network such as a local area network (LAN), wide area network (WAN) or the internet (not shown in FIG. 1).

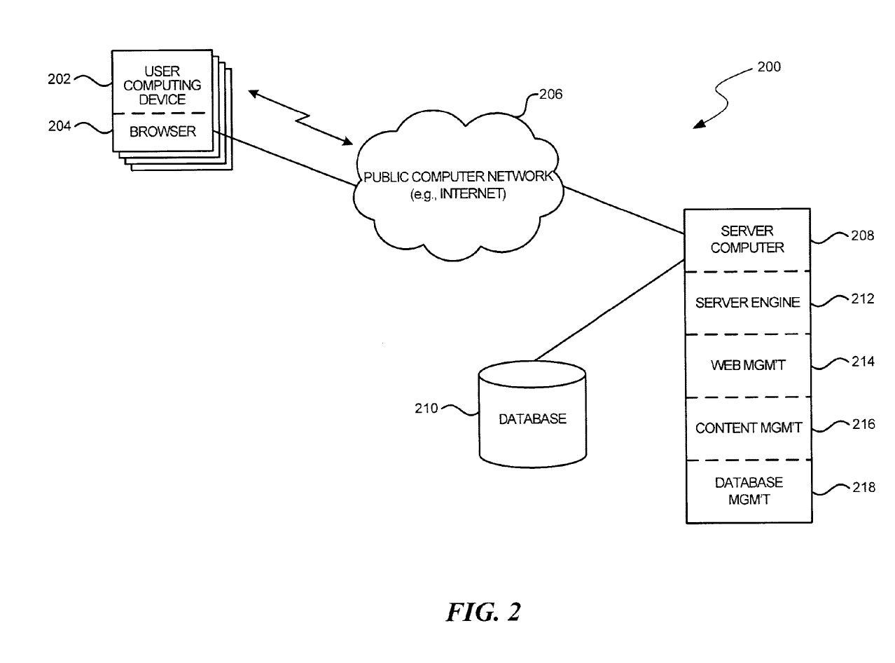

Aspects of the present technology may be practiced in a variety of other computing environments. For example, referring to FIG. 2, a distributed computing environment with a network interface includes one or more user computing devices 202 in a system 200 are shown, each of which includes a browser program module 204 that permits the computer to access and exchange data with the internet 208, including web sites within the World Wide Web portion of the Internet. The user computers may be substantially similar to the computing device 100 described above with respect to FIG. 1. User computing devices 202 may include other program modules such as an operating system, one or more application programs (e.g., word processing or spread sheet applications), and the like. The computing devices may be general-purpose devices that can be programmed to run various types of applications, or they may be single-purpose devices optimized or limited to a particular function or class of functions, More importantly, white shown with network browsers, any application program for providing a graphical user interface to users may be employed, as described in detail below; the use of a web browser and web interface are only used as a familiar example here,

At least one server computer 208, coupled to the Internet or World Wide Web (“Web”) 206, performs much or ail of the functions for receiving, routing and storing of electronic messages, such as web pages, data streams, audio signals, and electronic images. While the Internet is shown, a private network, such as an intranet, may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computing devices. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 218 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, read and write functions to the database and storage of data such as video, graphics and audio signals.

Many of the functional units described herein have been labeled as modules, in order to more particularly emphasize their implementation independence. For example, modules may be implemented in software for execution by various types of processors, such as processor 101. An identified module of executable code may, for instance, comprise one or more physical or logical blocks of computer instructions which may, for instance, be organized as an object, procedure, or function. The identified blocks of computer instructions need not be physically located together, but may comprise disparate instructions stored In different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations invading over different storage devices, and may exist, at least partially, merely as electronic signals on a system or network.

### B. System Components

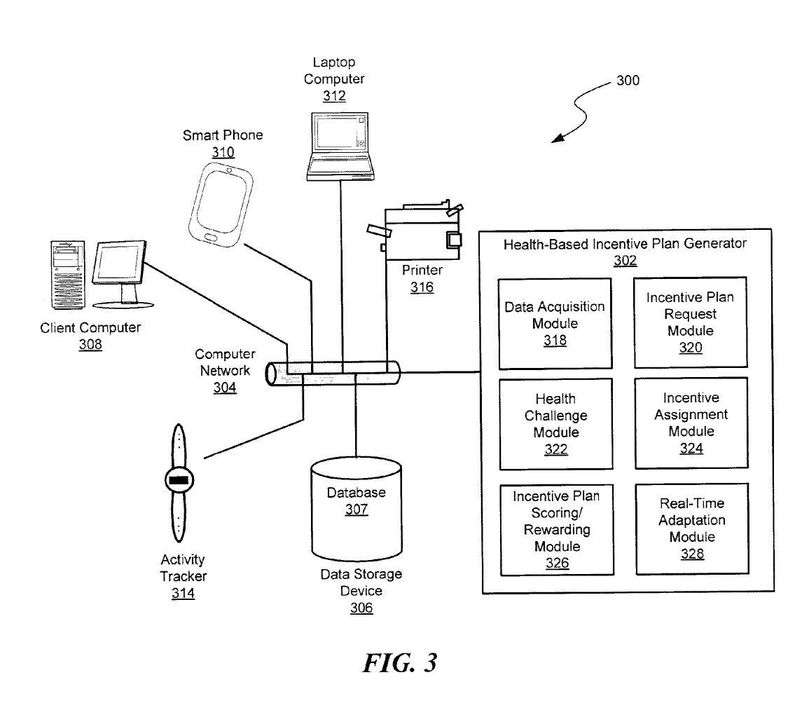

FIG. 3 depicts a health-based incentive plan system 300 for generating user-specific incentive plans and anticipated health benefit results in accordance with an embodiment of the present disclosure. Use of the system 300 can provide users as welt as medical practitioners with technical tools for capturing data related to a user's current health status as well as desired health status -outcome, and analyzing the data sets relative to incentive plan data sets (e.g., user-specific data and images, pre-determined incentive plans, general wellness knowledge information and previously acquired information relating So health conditions, incentive parameters and options, desired results and/or benefits, general information known in the art, etc.). The system 300 can further provide users and/or medical practitioners with best-fit incentive parameters for achieving m near as possible the desired health benefit outcome, and communicating an anticipated health benefit outcome to the user. For example, in some embodiments, the system 300 can generate visual images and/or a read-out of physiological condition ranges of a user's current health status as well as generate simulated images and/or physiological condition ranges depicting the anticipated outcome of incentive plan participation and compliance, The simulated image can be generated from the general wellness and previously acquired information stored and accessed from database(s), or in another embodiment, the simulated image and/or desired physiological condition ranges can be created by the system user (e.g., the user or incentive plan participant, medical practitioner, etc.). The system 300 can generate one or more user-specific health-based incentive plans for achieving the desired and/or anticipated health benefit outcome, and in some embodiments, direct monitoring systems to monitor incentive plan compliance for determining reward offerings, goal setting and future incentive plan benchmarks.

The system 300 includes a health-based incentive plan generator 302, which can reside on a server such as server 208, in communication with client computers, such as personal computer 308, smart phone 310, laptop computer 312, activity tracker 314 (e.g., wristband, watch, clip-on pedometer, GPS device, etc,), etc. (“client computer”), through a computer network 308. The computer network 304 can be substantially similar in structure and function to computer network 208. The health-based incentive plan generator 302 can be in communication with a data storage device 308 which can be a repository for one or more databases 307. The system 300 can also include a printer 318, and/or other devices in communication with the health -based incentive plan generator 302 through the computer network 304.

The health-based incentive plan generator 302 is capable of receiving user-specific data and other information relating to incentive plan requests, comparing user-specific data to the incentive plan data sets and previously acquired information stored and accessed from database(s) 307, calculating a best-fit combination of incentive parameters and formulating a user-specific incentive plan. The requests and/or incentive plan(s) can be communicated through the computer network 304 to/from one or more requesting client computing devices. Medical practitioners conducting remote physical examinations in which aspects of a patient's health or medical condition is manually examined by the practitioner or is evaluated or assessed by one or more medical devices or procedures, can enter, download, or otherwise input data into a client computing device for transmitting the data to the health-based incentive plan generator 302.

The health-based incentive plan generator 302 can be associated directly with a provider of health related information, health insurance companies, health and/or fitness organizations, employers, and/or providers of health-based products or the like relating to incentive plans. For example, the health-based incentive plan generator 302 can be associated with a service provider or clinical database manager (e.g., hospital, privately or publicly held company, third party organization, etc.). In another embodiment, the health-based incentive plan generator 302 can be associated directly with a provider and/or manufacturer of an activity tracker (e.g., that may include an accelerometer, altimeter, and/or GPS to calculate distance walked/run along with intensity of the exercise taken), in one particular embodiment, the activity tracker can include an UP²⁴⁰⁰ or UP band® from Jawbone, of 99 Rhode island Street. 3rd Floor, San Francisco, Calif. 94103. In some embodiments, the health-based incentive plan generator 302 is in direct communication with the network 304, which can be operatively connected to medical institutions and/or medical service providers, health and/or fitness clubs, weight-loss organizations, etc. for providing incentive plans for improving general health and/or addressing pre-existing medical conditions, in a further embodiment not shown, the health-based incentive plan generator 302 and data storage device 306 can be hosted directly on an individual client computing device and be used to generate user-specific health-based incentive plans in an on-site capacity. In this embodiment, the client computing device and/or data storage device 308 may be connected to the network 304 for transmitting updated information (e.g., new incentive information, user scores, health based goals and instructions, data libraries, software updates, etc.) in real-time or in a periodic manner.

As illustrated in FIG. 3, the health-based incentive plan generator 302 can include a data acquisition module 318, an incentive plan request module 320, health challenge module 322, an incentive assignment module 324 and an incentive plan scoring/rewarding module 328. In other embodiments, the health-based incentive plan generator 302 can also include one or more additional modules, such as a real-time adaptation module 328, all of which will be described in detail below, in general, modules 318, 320, 322, 324, 326 and 328 comprise listings of executable instructions for implementing logical functions which can be embodied In any computer readable medium for use by or in connection with instruction execution system or device (e.g., computer-based system, processor-containing system, etc.).

The data acquisition module 318 can be included for receiving user-specific data from the client computing devices (e.g., via operator input, wireless upload, file download, etc.), wherein the data relates to a specific user's current heath status, activity and/or behaviors. The data acquisition module 318 is further configured to create a user-specific health status data set from the received data. The data acquisition module 313 can be configured to receive a plurality of data characterizing one or more data categories, such as physiological tests (e.g., blood pressure, electrocardiogram (ECG) results, blood sugar, cholesterol, cortisol levels, heart rate, blood O² saturation levels, weight, body mass index, body fat percentage, etc.), activity levels, nutritional intake, sleep measurements etc. In other embodiments, the data acquisition module 318 can receive additional health-related data relating to the specific-user's baseline health status (e.g., during an initial data input). For example, the user-specific data may also include indication of a pre-existing medical condition, medical history, genomic data, family medical history, current medications, etc. The data acquisition module 318 can receive and categorize the user-specific data, for example, by formatting the data and/or extracting the data from one or more images, if additional data is required, the data acquisition module 318 can query the user for the additional information during the data acquisition logic steps.

The incentive plan request module 320 can be provided to receive an incentive plan request from the client computer. In one embodiment, the request indicates a user-specific health status data set upon which to base the incentive plan. The incentive plan request module 320 is further configured to initiate an incentive plan generation session corresponding to the indicated user-specific health status data set. Fallowing reception and categorization of user-specific health status data by the data acquisition module 318, the incentive plan request module 320 can be invoked upon receiving a user request from a client computer to generate an incentive plan based upon at least one user-specific health status data set and, in some embodiments, at least one health-based objective, if an incentive plan is requested, the incentive plan request module 320 searches the data storage device 306 to locate and retrieve 1) the user-specific health status data set, and, if indicated, 2) the user-specific objective(s).

The incentive plan request module 320 can also retrieve a plurality of previously acquired or general wellness data sets (the “incentive plan data sets”) for comparison to the user-specific data sets. The incentive plan data sets can Include information such as the starting or plan initiation data points (i.e., variable health status parameters common before incentive plan initiation) and the objective data points (i.e., actual and/or theoretical health status results achievable while using the incentive plan). The incentive plan data sets also correspond to unique combinations of health improvement parameters (e.g., goats, challenges, activity regimes, nutrition recommendations, etc.).

The incentive plan request module 320 can invoke search and retrieve functions to collect, the appropriate data sets from the appropriate databases 307. The health challenge module 322 can receive the accumulated set of search results from the invoked incentive plan request module 320 and rank the plurality of incentive plan data sets in accordance with a degree of affinity to the 1) user-specific health status data set, and, if included in the request, 2) the user's health objectives. Those of ordinary skill in the art will recognize that “ranking” means assigning an order of relative value to each incentive plan data set with respect to the other incentive plan data sets in the database 307.

For example, a relative ranking code may be assigned to each compared incentive plan data set with a predetermined range, such as 1-100. Alternatively, the compared data sets may be ordered in accordance with their relative value; or, a combination of ordering and ranking codes may be utilized. In other various embodiments, compared data sets may be dropped from the accumulated result set when the degree of affinity is below a pre-determined threshold value. The resulting collection, following the aforementioned ranking/pruning process, can be referred to as a sub-collection of incentive plan data sets from which data weighting, additional data entry and other optimization can reduce to a yet more refined sub-collection of data sets.

In one embodiment, the health challenge module 322 can generate and transmit to the client computer a first health-based challenge program which, for example can include one or more health-based challenge goals associated with a high ranked incentive plan data set. For example, the health challenge module 322 can generate a display (e.g., textual, graphical or other display) of one or more health-based challenge goats (e.g., activity challenges, nutrition changes, sleep pattern goals, etc.) associated with the highest ranked incentive plan data sets and/or a combination of incentive plan data sets to present the user with a best fit program, or in another embodiment, a program selection of challenge goals, in some embodiments, the user may be able to approve or otherwise accept a health-based challenge program or may request a different health-based challenge program. In various embodiments, the health challenge module can assign a user a challenge program of shorter duration (e.g., a day, a week, etc.) or longer duration (e.g., a month, a year, etc.). In various arrangements, the challenge program can include a plurality of program sessions, for example, of shorter duration (e.g., a day, a week etc.). The program sessions can provide accountability and opportunities to incentivize users to adhere to the program.

The health challenge module 322 can also be configured to generate and transmit to the client computer a predicted and/or a desired post-challenge result/outcome (e.g., weight loss, improved blood pressure measurement, improved blood sugar management, lower cholesterol, improved resting heart rate, improved blood O₂ saturation levels, improved muscle strength, etc.). In one embodiment, the prediction of the post-challenge result/outcome can be a display of one or more of the highest ranked incentive plan data sets (e.g., from the highest ranked incentive plan data set, a composite of a plurality of highly ranked incentive plan sets, etc.), wherein the incentive plan data sets are ranked according to a level of affinity to the user-specific objectives. In some aspects of the technology, user-specific objective data may not be received. As such, the health challenge module 322 can be configured to generate a desired post-challenge result/outcome based on medical personal knowledge and/or general advice, in some embodiments, the health challenge module 322 does not generate and/or transmit desired or predicted post-challenge outcomes.

The incentive assignment module 324 can be configured to receive additional data from the client computer to assess desirable or likely desirable incentives and/or rewards for awarding participants for meeting incentive plan goals or challenges. As such, the incentive assignment module 324 can be invoked to query the client computer. In some embodiments, the incentive assignment module 324 can assess and/or assign a difficulty level of an accepted and/or issued incentive plan to a particular user. As such, the incentive assignment module 324 can further offer a reward to the user for meeting the challenge goals formulated in the health-based challenge program. In some embodiments, the reward can be defined at the same time as the health-based challenge program. In other embodiments, the reward can be defined at a later time (e.g., upon completion of health-based challenge program or program interval). In particular embodiments, the incentive assignment module 324 may rank or value a plurality of incentives available for offer and offer a particular incentive or choice of incentives from the available incentives to a user for completing a particular health-based challenge program or program interval. For example, the incentive assignment module 324 may offer a high value incentive for completing a challenge program with a high difficulty rating, and a lower value incentive for completing a challenge program with a lower difficulty rating, in some embodiments, incentives can be tangible goods or services. In other embodiments, incentives can be points that are earned, awarded, accumulated, and/or accrued. In further embodiments, the incentives cars be points or other scoring methods wherein the points can be exchanged for tangible goods or services immediately or accumulated for exchange at for a later time.

The health-based incentive plan system 300 facilitates periodic, ongoing evaluation of a users actual, monitored progress in response to the accepted health-based challenge program as well as general heath/wellness goals of the user. In one embodiment, the incentive plan scoring/rewarding module 326 can be configured to award incentives (e.g., points, goods/services, etc.) to a participating user on a random or at undetermined or unpredictable time intervals as long as the user is improving in one or more aspects of the program goals or personal health data categories. Accordingly, in certain embodiments, a reward may be given to a user before, during and/or after meeting incentive plan goals or challenges, and the incentive is not contingent on specific challenge successes.

In another embodiment, the incentive plan scoring/rewarding module 326 can be configured to compare a user's response data to the health improvement parameters (e.g., program goals) associated with the accepted health-based challenge program to assess if a user has met a criteria for earning an incentive (e.g., score, points, reward, etc.). Further, the incentive plan scoring/rewarding module 326 is configured to award the incentive if the criteria have been met in some embodiments, a user's response data can be collected and compared to the database 308 comprising health-based challenge programs of prior users and/or general wellness information, computer-simulated-derived, etc. which are collectively referred to as the “incentive plan data sets”. The user's progress at the particular point in time in the challenge program, e.g., program interval of 1 week, 1 month, 6 months, 1 year, etc., can be compared relative to the efficiency and efficacy time line demonstrated by the one or more incentive plan data sets.

In the instances wherein the actual response (e.g., challenges met, health-based outcome achieved) matches the expected response, the information generated from the new user can be added to the database 306. If the user's outcome differs from the anticipated outcome, a root cause analysis can be performed to identify the source of the difference. For example, such an analysis could determine if the source of the difference is a result of user-specific behavior (e.g., increased calorie consumption), prior medical condition, medication-related effects, or user-specific genetics or structural abnormalities not accounted for in the incentive plan data set (e.g., physical disability, psychological disability, financial changes, etc.) Alternatively, the analysis could determine if the result difference was due to human error, such as measurement error or data entry error. The analysis may also flag a user for possible system abuse/manipulation if a users actual response (e.g., health-based outcome, health improvement) does not match the expected results based on the user's indication of program participation. For example, if a user reports 50 minutes of activity per day but the current health-related data does not reflect the expected improvements to the users health, the user can be flagged for follow-up and/or questioned regarding actual activity level.

In instances wherein the actual response differs from the anticipated response, and wherein the root source analysis determined a verifiable cause for the difference that does not include human error or system abuse/manipulation, the information generated from the new user can be added to the database 306. If the number of incentive plan data sets in the database 306 is n, then the information generated from the new user can be added as the n^{th}+1 incentive plan data set. In some embodiments, such information may include additional data not routinely acquired during an initial baseline health assessment. In these instances, the system s newly acquired data can be used for querying future users and/or operators for more information for generating incentive plans for future users.

In one embodiment, the actual response/results obtained from a first health-based challenge program session can be utilized for generating future incentive plans for the same user (e.g., for generating and/or assigning future health-based challenge program sessions). In this embodiment, the incentive plan request module 320 can receive one or more unique identifier codes with the transmitted request. Presentation of the one or more unique identifiers can initiate a protocol run by the incentive plan request module 320 to retrieve the data sets corresponding to the one or more unique identifiers and preference (e.g., weight) these data sets with, or in another embodiment, over the incentive plan data sets when generating the health-based challenge program (e.g., by the health challenge module 322) or when assigning incentives and/or rewards for meeting one or more program goals, such as meeting the challenges presented in a program session (e.g., by the incentive assignment module 324).

In some aspects of the present disclosure, the system provides for real-time optimization of the incentive plan. For example, once the health-based challenge program is in progress, the incentive plan system 300 provides the capability of real-time monitoring the actual user response to the health-based challenge program. For example, a user's compliance to a program session (e.g., a weekly set of goals, a monthly set of goals, a subset of goals, etc.) can be reported in real-time to the system 300. In some embodiments, real-time feedback data can be collected in initial stages of a program session and compared to the predicted modeling data generated and/or compiled by the health challenge module 322.

Accordingly, the incentive plan generator 302 can also include the real-time adaptation module 328 configured to receive real-time feedback data during a challenge program session from the client computer. In one embodiment, the feedback data can include activity levels, such as detected by an activity tracker. The activity measurements can indicate, for example, ah amount and/or intensify of activity the user is participating in during a challenge program session. In other embodiments, the feedback data can include sleep patterns, caloric intake, etc.

In one embodiment, the feedback data (e.g., activity measurements, nutritional/caloric intake, sleep patterns, etc.) can be collected in real-time or at preselected time intervals during initial stages of a challenge program or, in other embodiments, a challenge program session. For example, the feedback data can include activity measurements collected one time per day for about the first 3 days to about 5 days of a health-based challenge program session, or in other embodiments, for the about the first 8 days, first 7 days, first month, etc. In some embodiments, certain feedback data, such as physiological data (e.g., weight, blood pressure, blood sugar) can be collected periodically while other feedback data (e.g., activity level, nutritional intake, etc.) can be collected in real-time.

The real time adaptation module 328 can also be configured to compare the real-time feedback data to the health-based program accepted and/or assigned to the user. The real-time adaptation module 328 can also be configured to calculate a difference between the real-time feedback data and the challenge program or program session parameters, if the real-time feedback data is significantly different (i.e., difference is greater than a pre determined threshold difference), the real-time adaptation module 328 can modify the best-fit combination of session parameters to generate a modified incentive plan The modified incentive plan can include a modified health-based challenge program or can include modified parameters (e.g., challenges, goals) associated with a program session as well as modified incentives offered for meeting the parameters. The modified incentive plan can be transmitted from the real-time adaptation module 328 to the client computer for changing the challenge program or session goals in real-time.

### C. Embodiments of User Systems and Interfaces

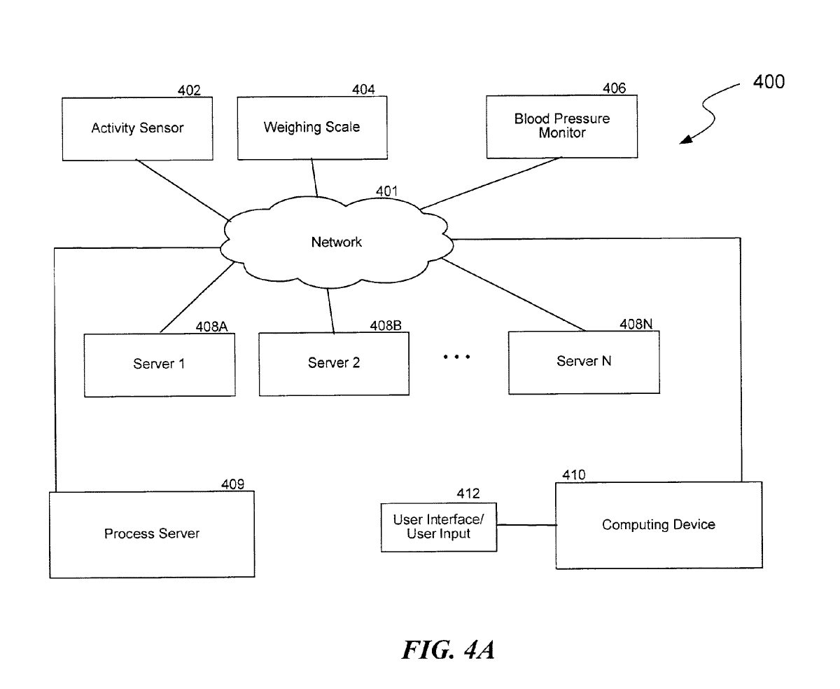

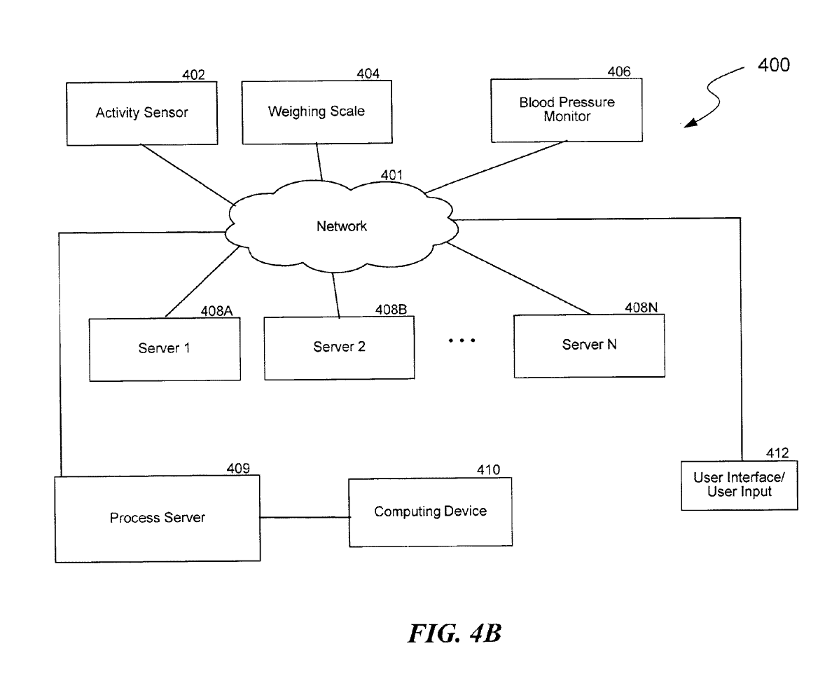

FIGS. 4A and 4B are schematic block diagrams illustrating environments 400 in which the system may operate in some embodiments. Referring to FIG. 4A, and in one embodiment, the environment 400 includes an activity sensor 402, a weighing scale 404 and, optionally, a blood pressure monitor 406 (e.g., for monitoring cardiac health) configured to capture the user-specific data and send it to one or more servers 408 (individually Identified as server 1 408A, server 2 408B, and server N 408N). In some embodiments, the health-based incentive plan generator 302, (FIG. 3) can reside on a process server 409 in communication with the one or more servers 408. In several embodiments, the one or more servers 408 and/or the process server 409 may reside in the computing cloud or other computing platform in communication with computing networks 401 (e.g., an intranet, the internet, etc.). The servers 408 that receive the unique user-specific data from the user via the activity sensor 402, the weighing scale 404, blood pressure monitor 406 or other health-related data collection devices (not shown), generally have programmatic application program interfaces (APIs) that enable third party applications to integrate with the servers such that these APIs provide access to data within the servers. Access to private data, such as patient and/or user-specific data may also be allowed if it is granted by the server 408 and the user. The process server 409 collects user-specific data from the one or more servers 408 via the servers' APIs.

A computing device 410 may connect to network resources, such as the process server 409 and one or more data storage devices (e.g., data storage device 306, FIG. 3). The computing device 410 could be any display capable device with) minimal processing power. As examples, the computing device 410 may connect to the process server 409 to upload data logs, user information, health-based challenge program use information, and so forth. The computing device 410 may also connect to the process server 409 to download updates to software. The computing device 410 is further configured to receive user input from a user interface 412. As described above, the computing device 410 may connect lo network resources via a network (e.g., public computer network 206, FIG. 2; computer network 304, FIG. 3), such as the Internet or an Intranet, in one embodiment, the computing device 410 can receive health-based incentive plans and/or other related data generated from any one of devices 402, 404, 406, 412. In an alternative embodiment, shown in FIG. 48, the user interface/user inputs 412 can be received directly by the process server 409.

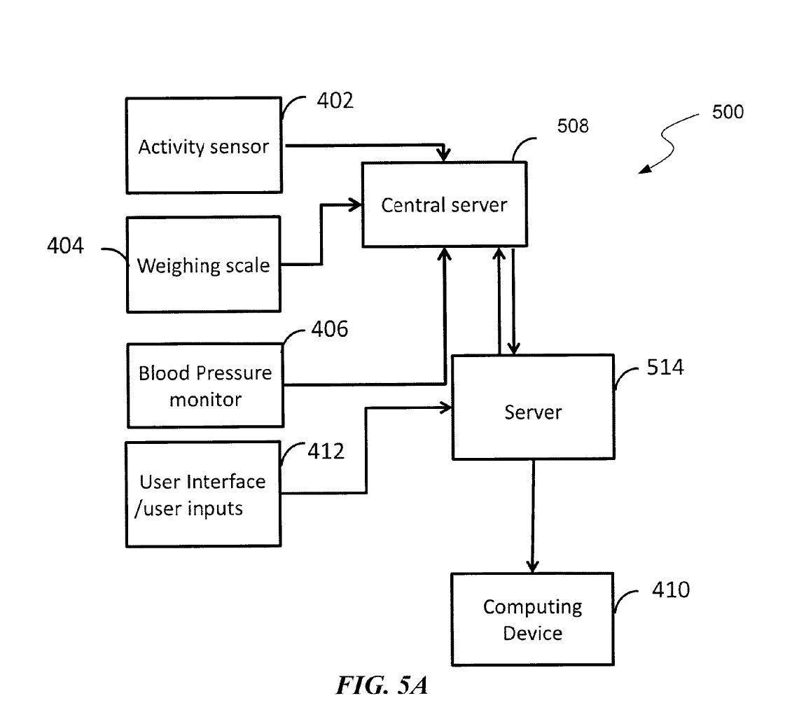

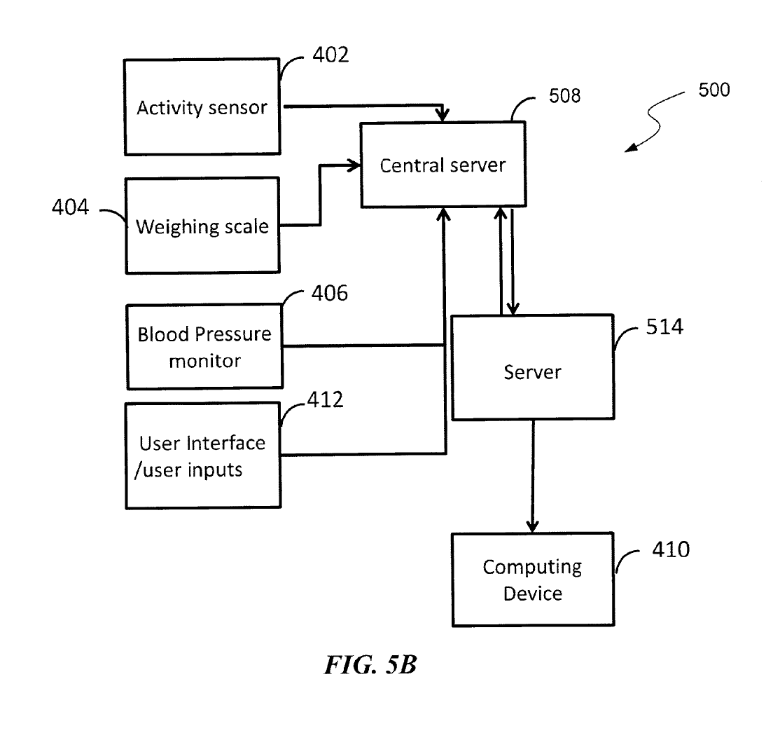

FIGS. 5A and 58 are schematic block diagrams illustrating environments 500 in which the system may operate in some embodiments. Several aspects of the environments 500 are similar to the environments 400 described with respect to FIGS. 4A and 48. For example, referring to FIG. 5A, the environment 500 includes the activity sensor 402, the weighing scale 404 and, optionally, the blood pressure monitor 408 (e.g., for monitoring cardiac health) configured to capture the user-specific data and send it to a central data collection server 508. The environment 500 also includes the computing device 410 connected to additional network resources, such as another server 514. As examples, the computing device 410 may connect to the server 514 to process data, inquiry databases and receive data from the user interface via user inputs 412. The health-based incentive plan generator 302, (FIG. 3) can reside on any one of servers 508 or 514, and accordingly, incentive plan requests can be transmitted through network resource connections. As described above, and as shown in FIG. 5B, the user interface/user inputs 412 can be received directly by the central server 508.

The user interface 412 can include various input devices for collecting input from a user, such as an operator of the system, and can also include various output devices, such as for providing information to the user, In some embodiments, the computing device 410 can be connected to the servers 408 and 409 (FIGS. 4A and 4B). and servers 508 and 514 (FIGS. 5A and 5B) to receive input from the health-based Incentive plan generator 302, (FIG. 3) and provide commands to the health-based incentive plan generator 302, (FIG. 3). Various components of the system may connect to other components via wired or wireless connections, such as Ethernet, serial (e.g., RS-232 or universal serial bus) connections, parallel connections, IEEE 802.11, IEEE 802.15, IEEE 802.16, “WiMAX,” IEEE 1394, infrared, Bluetooth, and so forth.

In other embodiments, additional measuring devices (not shown) and/or position determination devices (e.g., GPS units, etc.) can be connected to the computing device 410 and/or the servers 408, 409, 508, 514. Such devices may acquire data relating to blood sugar, heart rate, blood O₂ saturation levels, rapid eye movement durations, and so forth to characterize the baseline and/or current health status of a user. One of ordinary skill in the art will recognize other measuring devices and position determination devices for characterizing the health status of a user at baseline, at intermittent Intervals and/or in real-time.

FIG. 6 is a schematic block diagram illustrating subcomponents of the computing device 410 of FIG. 4A-5B in accordance with an embodiment of the present disclosure. The computing device 410 can include a processor 601, a memory 602 (e.g., SRAM, DRAM, flash, or other memory devices), input/output devices 603, and/or subsystems and other components 604. The computing device 410 can perform any of a wide variety of computing processing, storage, sensing, imaging, and/or other functions. Components of the computing device may be housed in a single unit or distributed over multiple, interconnected units (e.g., though a communications network). The components of the computing device 410 can accordingly include local and/or remote memory storage devices and any of a wide variety of computer-readable media.

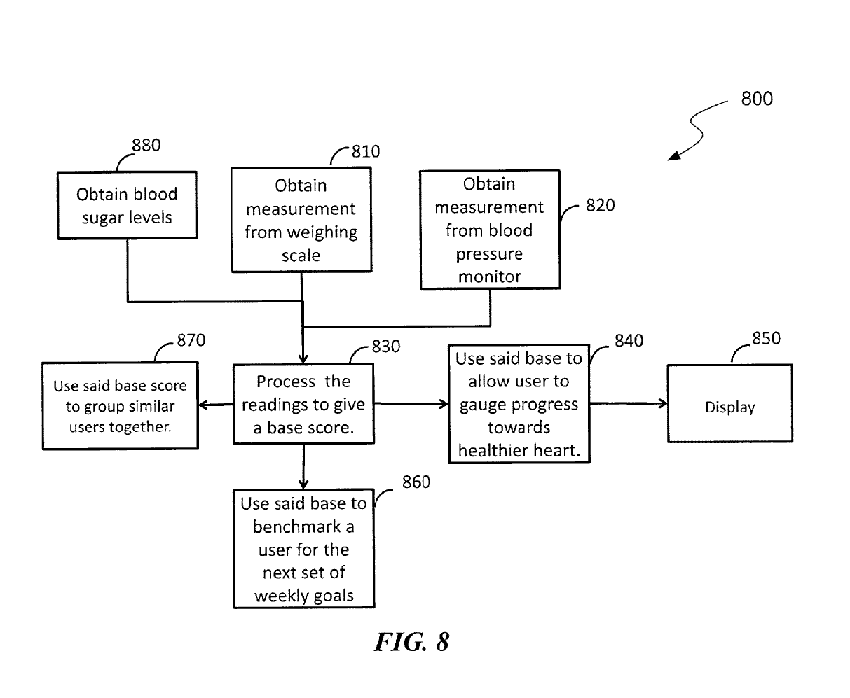

As illustrated in FIG. 8, the processor 601 can include a plurality of functional modules 606, such as software modules, for execution by the processor 601. The various implementations of source code (i.e., in a conventional programming language) can be Stored on a computer-readable storage medium or can be embodied on a transmission medium in a carrier wave. The modules 606 of the processor can include an input module 608, a database module 610, a process module 612, an output module 614, and, optionally, a display module 616.

In operation, the input module 608 accepts an user input via the one or more input devices described above with respect to FIGS. 1-5B, and communicates the accepted information or selections to other components for further processing. The database module 610 organizes records, including user records, incentive plan data sets, generated health-based challenge programs and sessions and incentive offerings and rewards, post-implementation results, and other user activities, and facilitates storing and retrieving of these records to and from a data storage device (e.g., internal memory 602, external database, etc.). Any type of database organization can be utilized, including a flat file system, hierarchical database, relational database, distributed database, etc.

In various embodiments, the processor 601 can be a standard central processing unit or a secure processor. Secure processors can be special-purpose processors (e.g., reduced instruction set processor) that can withstand sophisticated attacks that attempt, to extract data or programming logic. The secure processors may not have debugging pins that enable an external debugger to monitor the secure processor's execution or registers. In other embodiments, the system may employ a secure field programmable gate array, a smartcard, or other secure devices.

The memory 602 can be standard memory, secure memory, or a combination of both memory types. By employing a secure processor and/or secure memory, the system can ensure that data and instructions are both highly secure and sensitive operations such as decryption are shielded from observation.

### D. System Routines

The system invokes a number of routines. While some of the routines are described herein, one skilled in the art is capable of identifying other routines the system could perform. Moreover, the routines described herein can be altered in various ways. As examples, the order of illustrated logic may be rearranged, substeps may be performed in parallel, illustrated logic may be omitted, other logic may be included, etc.

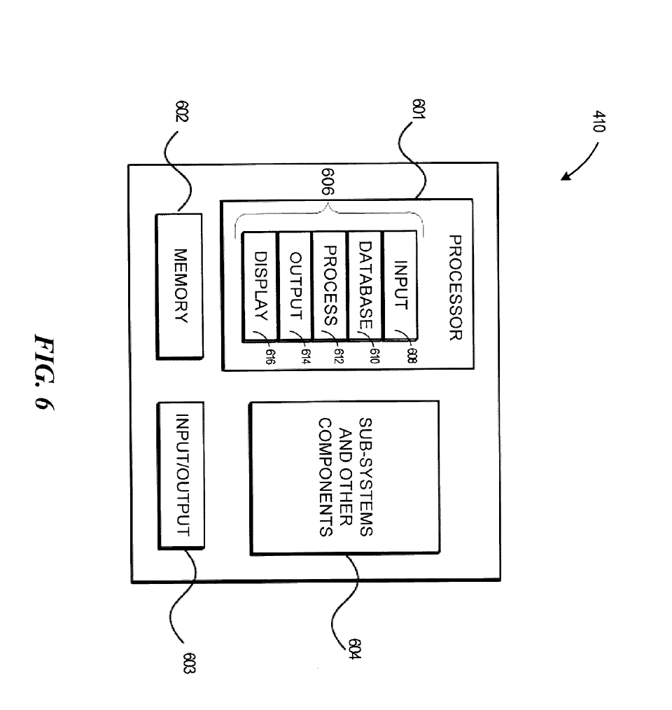

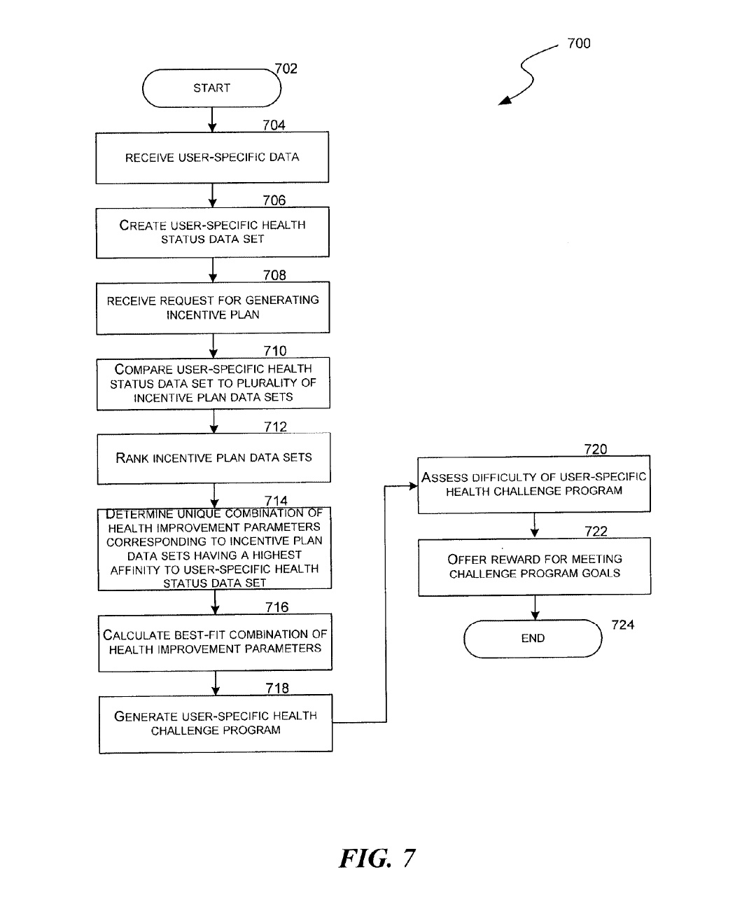

FIG. 7 is a flow diagram illustrating a routine 700 for generating a user-specific incentive plan invoked by the system in some embodiments. The routine 700 can be invoked by a computing device, such as a client computer or a server computer coupled to a computer network. In one embodiment the computing device includes the health-based incentive plan generator. As an example, the computing device may invoke the routine 700 after a user engages a user computing device or other interface in communication with the computing device via a computer network.

The routine 700 begins at block 702 and the data acquisition module receives user-specific data (e.g., general user information, user's baseline health status, current health status, activity and/or behaviors, etc.) (block 704) and creates a user-specific health status data set (block 708). In these embodiments, the user-specific data can be self-reported, objectively measured by one or more measuring devices and/or a combination of self-reporting and measurements.

The incentive plan request module receives a request for generating a user-specific incentive plan (block 708). The incentive plan request module compares the baseline and/or current health status data set(s) to a plurality of incentive plan data sets (block 710). The incentive plan data sets can correspond to unique combinations of possible health improvement parameters. For example, possible health improvement parameters can include health-related goals and challenges, activity regimes, nutrition recommendations, sleep recommendations, etc.

Following the comparing step, the health challenge module ranks the plurality of incentive plan data sets in accordance with a degree of affinity to the user-specific health status data set (block 712). Additionally, the health challenge module determines the unique combination of health improvement parameters corresponding to one or more incentive plan data sets having a highest affinity to the user-specific health status data set (block 714). In one embodiment, the one or more incentive plan data sets having the highest affinity to the user-specific health status data set include incentive plan data sets having an affinity over a pre-established threshold affinity.

In some embodiments, the incentive plan includes a health -based challenge program for improving one or more aspects of a user's health following compliance and/or participation by the user. At block 716, the health challenge module calculates a best-fit combination of health improvement parameters from the unique combination of health improvement parameters corresponding to the one or more incentive plan data sets having the highest affinity. In one embodiment, the best-fit combination can be a composite of health improvement parameters corresponding to multiple incentive plan data sets, in another embodiment, the best-fit combination can include the unique combination of health improvement parameters corresponding to a single incentive plan data set. At block 718, the health challenge module also generates the user-specific health challenge program for selection and/or acceptance by a user/participant. The health challenge program includes the best-fit combination of health improvement parameters, in certain embodiments, the health challenge program may be subdivided and or accepted as one or more program sessions. Sessions may include a subset of the health improvement parameters, one or more shorter durations for which to implement certain health improvement parameters, and/or one or more instances where the user provides current health status data such that one or more health improvement parameters can be altered.

Following the generation of the health challenge program, the incentive assignment module assesses and/or assigns a difficulty level of an accepted and/or issued health challenge program and/or program session (block 720). At block 722, the incentive assignment module offers a reward to the user for meeting the challenge program goals formulated in the health-based challenge program and/or program session. The routine 700 may then continue at block 724, where it ends.

FIG. 8 illustrates a method 800 of Improving one or more aspects of a user's heath in accordance with aspects of the present technology. In some embodiments, the method 800 comprises obtaining or determining a base health score 830, providing a user with a plurality of goals 860 to achieve in a program session having a predetermined period of time (e.g., one week), optionally enrolling a plurality of users having the same or similar base health scores into a group 870, and displaying (e.g., electronically displaying) to the user a score associated with achieving or partially achieving one or more of the plurality of goals 850.

In some embodiments, the step of obtaining or determining the base health score 830 includes obtaining a measurement from a weighing scale 810, and/or obtaining a blood pressure measurement from a blood pressure monitor 820. In other embodiments, additional or alternative measuring devices (e.g., blood sugar monitor, heart rate monitor, etc.) can be used to obtain additional base health score defining information. For example, the method 800 can include obtaining blood sugar levels 880 as part of determining the baseline score.

In some embodiments, the users base health score 830 is calculated based on the user's daily activities for an initial period of time. Based on the base health score 830, the system produces a health-based challenge program 860 including clinically proven health-enhancing activities, completion of which is likely to reduce the user s risk of developing or worsening a disease or disorder.

In specific embodiments, the clinically proven health-enhancing activities 860 include a plurality of health-based challenge goals including activity challenges, nutrition and/or diet challenges, and sleep pattern goals. The system assembles a session (e.g., a program session) which includes a series or subset of the clinically proven health improvement parameters discussed above (e.g., cardiovascular activities, nutrition recommendations, sleep recommendations, etc.), each associated with a point value, for example. Each program session can thus include an aggregate target score (e.g., the sum of the point values assigned to all of the activities in a given program session) to be attained by the user within a predetermined time interval associated with the session, for example within one week. If the user achieves one or more of the challenges during the predetermined time interval, the user is eligible for the incentive at the end of the session. The target score cars be adaptable, for example, in some embodiments, the system (e.g., via the real-time adaptation module 328; FIG. 3) adjusts or resets the require merits of one or more of the challenges or the point value assigned to one or more of the challenges during the session (e.g., before the end of the predetermined time interval). The target score can be set depending on the user's average daily activities and/or current health status, for example, in other embodiments, incentives can be awarded to a user randomly, either before or after the user achieves certain program goals or challenges as long as the user demonstrates progress with respect to the program goals.

In some embodiments, the user's base health score 830 includes data indicating that the user has a cardiovascular-related disease or disorder, or is at risk of developing a cardiovascular-related disease or disorder, in such embodiments, the health-based challenge program 860 includes clinically-proven cardiovascular health-enhancing activities. In some embodiments, the clinically proven cardiovascular activities 860 include a combination of cardiac health-based challenge goals including activity challenges, nutrition challenges, and steep pattern goals. In other embodiments, the user's base health score 830 can include data indicating the user has or is at risk of developing other diseases or disorders (e.g., diabetes, inflammatory diseases, etc.).

In some embodiments, the method 800 further comprises rewarding the user at random or predetermined intervals, or if the user meets an individual goal before the end of the corresponding session, instead of or in addition to providing a reward at the end of the program session. In some examples, the program session score earned by the user in a program session is based on the users physical activity (including the user's level of exertion), nutritional intake, and physiological heart attributes during the session. The session score may also include point values from calories consumed and/or burned, blood sugar levels (e.g., changes in blood sugar levels during the session), weight (e.g., changes in the user's weight since the beginning of the session), BMI (Body Mass Index, including changes in the user's BMI during the session), blood pressure (e.g., changes in the user's blood pressure during the session), MAP (Mean Arterial Pressure, including changes in MAP during the session), pulse pressure (e.g., changes in the user's pulse pressure during the session) and hours/quality of sleep of the user. In one embodiment, such user-specific current health status data can be measured and retrieved automatically from various sensors and stored in one or more databases for concurrent or later analysis. In some embodiments, however, the current health status data can be manually assessed and entered/uploaded to system servers and databases.

In some embodiments, the blood pressure, MAP and pulse pressure are taken automatically via a wireless (WiFi/Bluetooth) blood pressure monitor, the users weight and BMI are taken via a wireless (WiFi/Bluetooth) weighing scale, the user's activity information is taken via a wireless (WiFi/Bluetooth) activity tracker that may use an accelerometer, altimeter, and/or GPS to calculate distance walked or ran along with intensity of the exercise taken. In some embodiments, sleep duration and nutritional information can be logged manually by the user and/or using applications that calculate calories, sodium intake, and other related nutritional information, for example,

In a specific example, and before a session begins, a base health value or score can be determined based on the users current physiological parameters such as weight, BMI and blood pressure, and optionally, the user's body far percentage, genetic data, medical history, etc. Users having a healthy blood pressure can be given a high cardiac health value, while users with prehypertension, for example, can be given a lower base cardiac health value, and users having high blood pressure (e.g., stage 1) can receive an even lower base cardiac health value, etc. The user's base cardiac health value can also be influenced by the user's BMI, with healthier BMI values contributing a high score to the cardiac health value than users with BMI values that are higher or lower than the ideal or preferred BMI value or range for an individual having physiological parameters similar to the user. The baseline score 630 may also include values reflecting the presence of cardiac-related conditions, such as diabetes, high levels of cholesterol, high triglycerides, and so forth.

In some embodiments, the goals for the user (e.g., established in step 860) change depending on the users current health standing (determined by the baseline score 830), which can include pre-existing conditions. For example, the system may include initial health challenge program and/or program session goals that Include additional days of exercise if a user has high levels of cholesterol and/or triglycerides, compared to the session goals for a user who does not have high cholesterol and/or triglycerides. For example, the session goal for a user with high cholesterol and/or triglycerides may include at least 5 days of exercise in one week, such as 5 days, 6 days or 7 days per week, compared to a session goal of less than 5 days of exercise (e.g., 150 minutes of moderate exercise or 75 minutes of vigorous exercise) in one week for a user who does not have high cholesterol and/or triglycerides.

In some embodiments, an initial health challenge program and/or program session goals 880 can additionally include dietary goals based on the base health value. For example, a user with high levels of cholesterol and/or triglycerides can receive an initial health challenge program and/or program session goal that includes dietary goals that may emphasize reducing carbohydrates, saturated fat, trans fat, and/or dietary cholesterol

In some embodiments the method further comprises using a user's baseline health status score to associate (e.g., automatically associate, manually associate) or group users having similar scores and/or health related challenges together 870 into one or more groups to promote competition. For example, the system may automatically enroll all users having high cholesterol into a user group to promote competition to lower cholesterol values over time. Alternatively or in addition, the system may enroll (e.g., automatically associate) all users having a base cardiac health score into a user group to promote competition among users who will each receive session goals having similar difficulties. The competition between users having similar base cardiac health values is intended to encourage each individual user in the group to earn a better score than be or she ordinarily might.

In some embodiments, the system displays 850 scores earned by each user individually and/or as compared within a group during a program session, for example on a web page or smartphone application, in a native application, by sending an electronic message to each user in the group, or on an activity tracker such as a wrist-worn activity tracker. The displayed scores may be updated periodically, automatically or each time a user's score changes.

The baseline score may also be used by the system to determine what the goals for the next session (e.g., week) may be for the user. For example, the level of success or failure to meet certain program session goals (e.g., during a first session or week of participation in a health challenge program), can be used to determine a following session's level of difficulty for one or more of the session goals. For example, in some embodiments, the amount of effort required to earn a point or achieve goals in a session may be different for different users; a relatively healthy user may have to perform more rigorous activities or achieve more difficult goals compared to a relatively unhealthy user. An additional benefit of having a baseline score at an Initial starting point of user participation in a health-based incentive plan includes being able to use the baseline score to assess a user's progress towards achieving an improved health status (step 840).

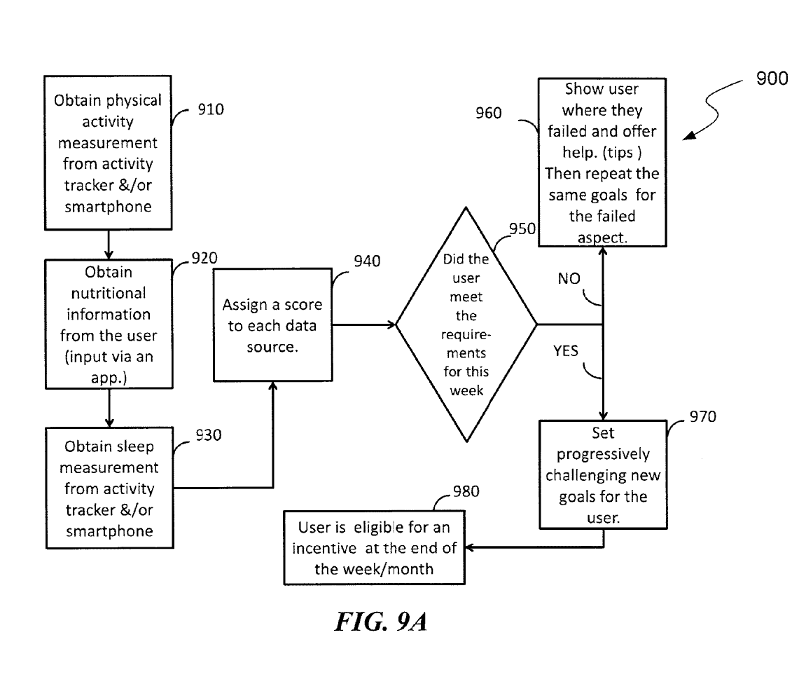

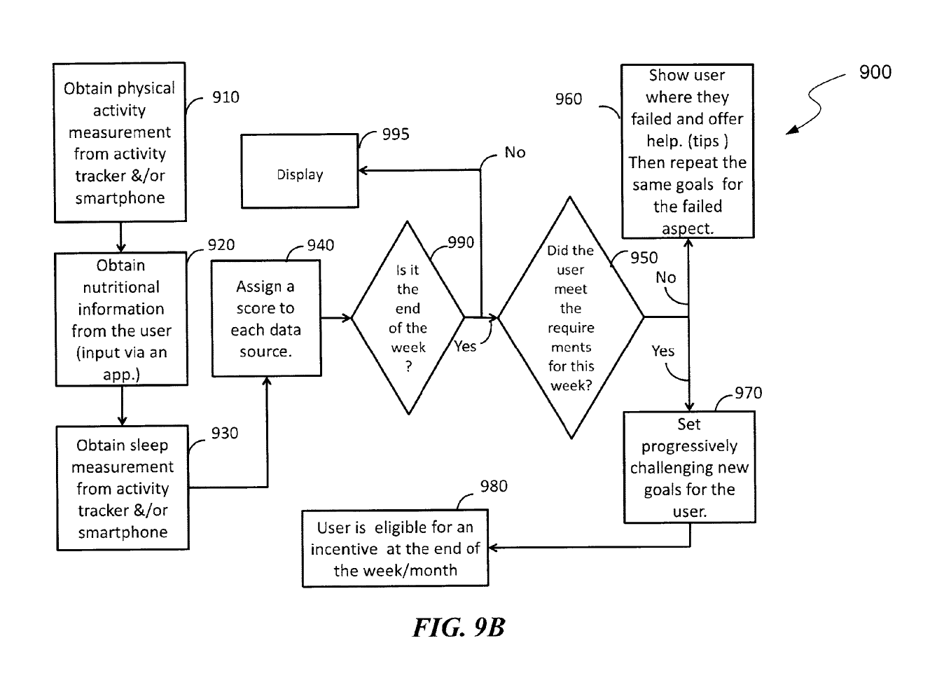

FIGS. 9A and 9B illustrate additional methods 900 of improving one or more aspects of a user's health by calculating a program session (e.g., weekly) score within the incentive plan in accordance with aspects of the present technology. Referring to FIG. 9A, the method 900 includes obtaining particular measurements or gathering user-specific date from an activity tracker/accelerometer or smartphone (block 910), obtaining nutritional information from the user (block 920), and obtaining sleep data (block 930). This data can be acquired by the data acquisition module 318 (FIG. 3) and compared to the health improvement parameters by the incentive plan scoring/rewarding module 326 (FIG. 3).

A scoring system can be used to assess compliance and achievement with respect to meeting a users program session goals and a session score (e.g., a weekly score) can be generated (block 940). For example, at the end of a session (e.g., a week), the system can evaluate if the user has met the requirements set for that session (decision block 950). If the requirements have not been met, the system can display or present to the user which requirements were not met and/or other challenge failures as well as offer help or tips for future program sessions (block 960). In some embodiments, the next session goals (e.g., for the following week) can be the same as the previous session, in other embodiments, the system can reduce the difficulty of tire session goats for the next session (e.g., next week) to make it less difficult for the user to meet the assigned goals. If the requirements for the program session have been met, the system can present progressively more difficult program session goals for the next session (block 970). Additionally, if program session goals are met, the user may be eligible to receive an incentive/reward at the end of the session and/or at the end of a predetermined number of sessions, time and/or after meeting certain long term goals (block 980).

FIG. 9B illustrates an alternative method flow 900 wherein users may be continually updated with their accumulated score levels to-date. For example, in the embodiment shown in FIG. 9B, and following the assigning of a score to each data source, decision block 990 asks if it is the end of the program session (e.g., week). If the answer is no, the score can be displayed to the user (block 995). If it is the end of the week, the method 900 can continue at decision block 950 as described above.

User-specific data used to calculate the base and session scores may be collected manually or automatically. In one specific example, a users physiological parameters may be gathered using a wireless weighing scale, wireless BP monitor and/or wireless activity/sleep tracker that automatically send data to a smartphone or upload directly to the cloud where it may be analyzed. In one embodiment, the session score can be updated frequently as data may be sent by the activity tracker frequently to the user's phone, PC, and/or tablet via Bluetooth or directly by WiFi to the health-based incentive plan generator. The blood pressure and weight measurements may be taken less frequently (e.g., once a week) to update the user-specific current health status data set, and the program session score can be updated on a continuous and/or intermittent basis as additional data is received, in some embodiments, nutritional information can be logged directly by the user into the user's computing device (e.g., smart phone, laptop, etc.), however, in other embodiments, nutritional information may be calculated via image recognition when a user takes a photo of their food before consumption. In some embodiments, a metadata analysis can ensure the photo of the food item taken was actually taken by the user's smartphone.

Additionally, the system may be capable of verifying the user's input information. For example, the nutritional information input by a user addressing a cardiac condition, can provide caloric difference along with sodium levels and the system may analyze this information to see if a current health status is improved over a baseline score. If nutritional information received by the system does not appear on trend for the user, the user may be flagged or pinged to ensure the input is correct, in cases where a user .has several flags, the program session incentive may be withheld. The system may also recommend the user be assessed by a medical practitioner if abnormal trends are identified.

In various embodiments, the scoring system may be used to support a game or other competition. For example, weekly session score and baseline score may be converted to points. In this example, as the user collects points they can attain new levels that signify progress towards the health-based challenge program goals and, optionally, for the user to compare themselves with other group members. The baseline score in turn can be used measure the user's health progress periodically.

In another embodiment, the health challenge program goals can be based on a user's non-healthy behavior that may be having an impact on the user's health status, in one embodiment, the goals and/or challenges to change the non-healthy behavior can be represented in program sessions (e.g., weekly goals) and can include negative and/or positive consequences to the user's incentive/reward (e.g., score, points, goods, services). For example, user-specific data collected by the data acquisition module 318 (FIG. 3) can be analyzed to identify both healthy and non-healthy habits, practices, behaviors, etc. that would have impact on the health status of the user. In one particular example, if soda consumption is common in a particular user's diet; reduction of the consumption of soda can be encouraged with offering incentives to remove soda from the user's diet. In one embodiment, if a user consumes more than 450 calories from soda (roughly 36 ounces) per day, the user can get flagged by the system as having a non-healthy behavior in some embodiments, various healthy and non-healthy behaviors can be dependent on the user's age, gender, location, ethnicity, cuisine preference and so forth.

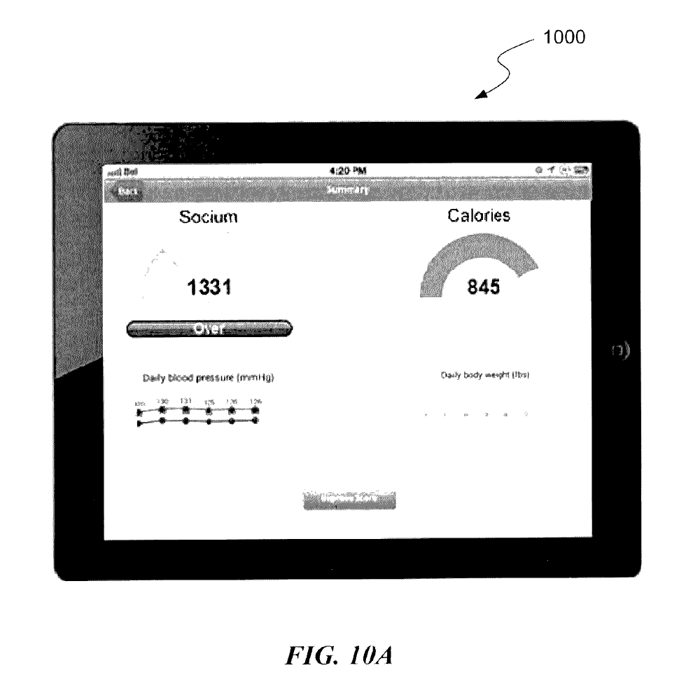

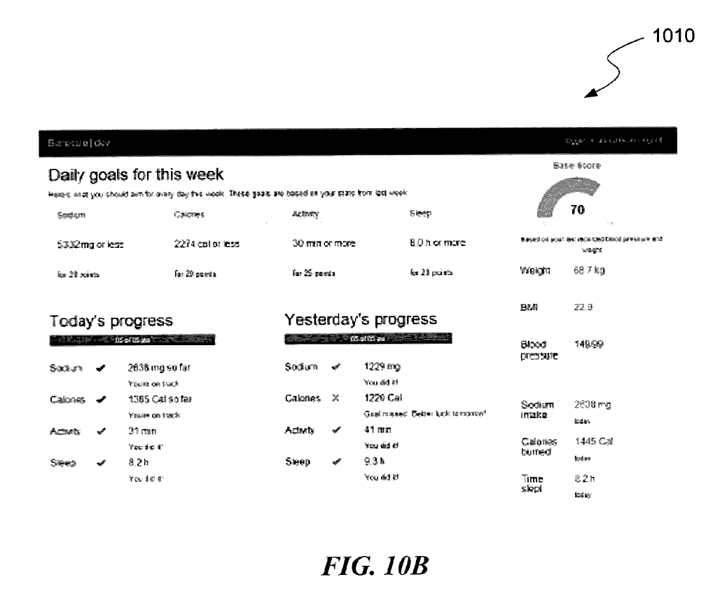

In one example, if a user fails to meet his or her program session goals, the system may be able to point out the specific habits, behaviors, and/or actions that need to be addressed and thus help the user take appropriate measures to meet the next session's goals. FIG. 10A illustrates a screen shot 1000 provided to the user by the incentive scoring/rewarding module 326 (FIG. 3) showing that the user's sodium intake was too high for a particular session interval. In this example, sodium intake reduction may be included in the following session's goals. FIG. 10B illustrates a screen shot 1010 provided to the user by the incentive scoring/rewarding module 326 and/or the real-time adaptation module 328 (FIG. 3) showing previous program progress and current user-specific goals.

In addition to providing incentive plans for improving a health status relating to the user's heart, the system can also be adapted to address specific indications for other diseases and disorders, such as diabetes. In one embodiment, the system can be configured to include a blood glucose measuring device. The system may also acquire user-specific knowledge associated with the users past medical history (e.g., blood sugar levels) as well as general wellness knowledge, The system can further include program session goals that will specifically address diabetic-specific behaviors and health improvement parameters (e.g., incentives offered for maintaining specialized diets) for controlling diabetes. In another embodiment, for an epileptic child, a physician may suggest a Ketogenic diet and the program session goals and incentives can be configured to encourage the user in following the specific diet of high fat, low carbohydrates.

In a further embodiment, the system can be adaptive such that the system can provide a health-based challenge program that changes over time in a user-specific manner. More specifically, the system can use a user's previous incentive plan compliance and health-based challenge program session achievements and/or failures to propose differential challenges and/or a change in challenge difficulty during a following session. For example, the system can assess a user's current health status and current program session goals to determine a subsequent sessions goals, such as to make the following session more challenging. In a specific example where program session goals are scored on a weekly basis, an adaptive system can encourage users to reach a higher point score for subsequent week, such as if a static scoring fable is being used. In another embodiment, a set target score (e.g. 100) can be required to be reached every week but the goals needed to achieve the target score can become more challenging as the user progresses within the health-based challenge program.

In various embodiments, if a user fails to meet the current session's goals (e.g., weekly goals), the system may repeat the same goats for the next session or, alternatively, offer an easier goal to achieve along with tips to meet the goal. In an adaptive system, the program sessions can be temporarily set such that each session can last a pre-determined period of time (e.g., day, week, biweek, month, etc.). Scoring performance of a participating user can include assessing a score for every day, every week, every biweek, etc., and progressive goals can be set for each next session period. In one embodiment, averages of scores for particular sessions can be used to determine the heath improvement parameters for following sessions. A daily and/or biweekly variable score may also be calculated on principles similar to the weekly score wherein the user's activity is scored depending on importance to health.

### E. Conclusion

Various embodiments of the technology are described above. It will be appreciated that details set forth above are provided to describe the embodiments in a manner sufficient to enable a person skilled in the relevant art to make and use the disclosed embodiments. Several of the details and advantages, however, may not be necessary to practice some embodiments. Additionally, some well-known structures or functions may not be shown or described in detail, so as to avoid unnecessarily obscuring the relevant description of the various embodiments. Although some embodiments may be within the scope of the claims, they may not be described in detail with respect to the Figures. Furthermore, features, structures, or characteristics of various embodiments may be combined in any suitable manner. Moreover, one skilled in the art will recognize that there are a number of other technologies that could be used to perform functions similar to those described above and so the claims should not be limited to the devices or routines described herein. While processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, white, processes or blocks are at times shown as being performed in series, these processes or blocks may instead be performed in parallel, or may be performed at different times. The headings provided herein are for convenience only and do riot interpret the scope or meaning of the claims.

The terminology used in the description is intended to be interpreted in its broadest reasonable manner, even though it is being used in conjunction with a detailed description of identified embodiment.

Unless the context clearly requires otherwise, throughout the description and the claims, the words “comprise” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items In the list, and any combination of the items in the list.

Any patents, applications and other references, including any that may be listed in accompanying filing papers, are incorporated herein by reference. Aspects of the described technology can be modified, if necessary, to employ the systems, functions, and concepts of the various references described above to provide yet further embodiments.

These and other changes cars be made in light of the above Detailed Description. While the above description details certain embodiments and describes the best mode contemplated, no matter how detailed, various changes can be made. Implementation details may vary considerably, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the claims to the specific embodiments disclosed in the specification, unless the above Detailed Description section explicitly defines such terms. Accordingly, the actual scope of the claims encompasses not only the disclosed embodiments, but also all equivalents.

I/We claim;

1. A system for generating a user-specific incentive plan for improving a user's health comprising:
a computer network for transmitting information relating to a user's health status, wherein the information includes one or more of the incentive plan requests, data, images, and incentive plans;
a client computer associated with a user and in communication with the computer network;
a database connected to the computer network for storing a plurality of incentive plan data sets and a plurality of health improvement parameters, wherein the plurality of incentive plan data sets correspond to unique combinations of the health improvement parameters; and
a health-based incentive plan generator in communication with the computer network and configured to receive user-specific data and incentive plan requests from the client computer, compare user-specific data to the plurality of incentive plan data sets in the database, and calculate a best-fit combination of health improvement parameters from the plurality of health improvement parameters to generate the user-specific incentive plan.

2. The system of example 1 wherein user-specific data Includes a user-specific health status, activity level and behavior,

3. The system of example 2 wherein the health-based incentive plan generator comprises:
a data acquisition module configured to—
receive user-specific data from the client computer to create a user-specific health status data set, the user-specific data relating to at least the users current health status; and
deposit the user-specific health status data sets into one or more data set libraries stored in the database;
an incentive plan request module configured to—
receive an incentive plan request from the client computer, wherein the
request indicates the user-specific health status data set; retrieve the user-specific health status data set and the plurality of
incentive plan data sets from the database; and initiate an incentive plan generation session, wherein the session corresponds to the indicated user-specific health status data sets;
a health challenge module configured to—
rank the plurality of incentive plan data sets in accordance with a degree of affinity to the user-specific health status data set;
calculate the best-fit combination of health improvement parameters from the plurality of health improvement parameters by determining the unique combination of health improvement parameters corresponding to one or more Incentive plan data sets having a highest affinity to the user-specific data; and
generate a health-based challenge program having the health improvement parameters;
an incentive assignment module configured to offer a reward to the user for meeting challenge goals defined in the health-based challenge program

4. The system of example 3 wherein the health-based incentive plan generator further comprises an incentive plan scoring and/or rewarding module configured to—
compare a user's response data to the health improvement parameters associated with the accepted health-based challenge program to assess if the user has met a criteria for earning an incentive; and
award the incentive if the criteria has been met.

5. A method performed by a system for providing a user-specific incentive plan, comprising:
receiving user-specific data to create a user-specific health status data set
relating to at feast a user's current health status; receiving an incentive plan request;
generating a health-based challenge program for improving one or more aspects of the user's current health status; and
providing art incentive based on improvement of the user's current health status,

6. The method of claim 5, further comprising displaying the user-specific incentive plan, wherein the incentive plan includes a calculated best-fit combination of health-based challenges for achieving an improved current health status.

7. The method of claim 5, further comprising receiving additional user-specific data for modifying one or more parameters of the health-based challenge program.

8. A computer-readable storage medium storing computer-executable instructions, comprising:
instructions for receiving a users health data from one or more health monitoring devices;
instructions for generating and providing a health-based challenge program to the user to improve one or more health-based parameters specific to the user;
instructions for monitoring the user's health data; and
instructions for providing incentive to the user to continue to participate in the health-based challenge program in a manner that improves the one or more health-based parameters.

9. The computer-readable storage medium of claim 8, further comprising instructions for assessing improvement of the one or more health-based parameters.

10. The computer-readable storage medium of claim 8 wherein the instructions for monitoring the user's health data are instructions for monitoring the user's health data in real-time.

11. A system as substantially described herein.

12. A method as substantially described herein.
